(19) United States
(12) Patent Application Publication
(10) Pub. No.: US 2024/0205107 A1
(43) Pub. Date: Jun. 20, 2024

(54) ML BASED FAIR FLOW CONTROL MECHANISM FOR TCP IN CORE NETWORK

(71) Applicant: SAMSUNG ELECTRONICS CO., LTD., Suwon-si (KR)

(72) Inventors: Vasanth Kanakaraj, Bangalore (IN); Shreyanshu Agarwal, Bangalore (IN); Issaac Kommineni, Bangalore (IN); Vishal Murgai, Bangalore (IN); Anish Nediyanchath, Bangalore (IN); Gaurav Jha, Bangalore (IN); Naveen Kumar Srinivasa Naidu, Bangalore (IN); Sukhdeep Singh, Bangalore (IN)

(73) Assignee: SAMSUNG ELECTRONICS CO., LTD., Suwon-si (KR)

(21) Appl. No.: 18/593,390

(22) Filed: Mar. 1, 2024

Related U.S. Application Data
(63) Continuation of application No. PCT/KR2023/018003, filed on Nov. 9, 2023.

(30) Foreign Application Priority Data
Dec. 14, 2022 (IN) 202241072349
Oct. 3, 2023 (IN) 202241072349

(51) Int. Cl. H04L 41/5009; H04L 41/16; H04W 28/08

(52) U.S. Cl. CPC H04L 41/5009; H04L 41/16; H04W 28/0967

(57) ABSTRACT

A method of providing congestion control and reducing latency of data incoming to a core network, the method performed by a control plane gateway, includes: monitoring values of key performance indicators (KPIs) associated with a plurality of user plane gateways in the core network; predicting, using a machine learning (ML) model, an optimal window size respectively for each of the plurality of user plane gateways, based on the monitored values of the KPIs; and transmitting the optimal window size to the respective user plane gateway in the plurality of user plane gateways.

### CROSS-REFERENCE TO RELATED APPLICATIONS

This application is a by-pass continuation application of international application no. PCT/KR2023/018003, filed on Nov. 9, 2023, which is based on and claims priority to an Indian provisional application number 202241072349, filed on Dec. 14, 2022, in the Indian Intellectual Property Office, and an Indian complete application number 202241072349, filed on Oct. 3, 2023, in the Indian Intellectual Property Office, the disclosures of which are incorporated by reference herein their entireties.

### BACKGROUND

### 1. Field

The disclosure relates to a cellular network in telecommunications. The disclosure relates to a method and a system related to a machine learning (ML) based fair flow control operations on incoming packets (such as Transmission Control Protocol (TCP)) in a network (such as a core network in fifth generation (5G)).

### 2. Description of Related Art

The Fifth Generation (5G) technology is designed to provide high-speed, low-latency, and reliable communication services, enabling the delivery of large volumes of data. Data often flows from the internet server to User Equipment (UEs). This 5G technology has enabled the seamless transmission of large volumes of data across wireless networks. This 5G technology, which is combined with larger Dynamic Random Access Memory (DRAM) available in the UEs, can often lead to larger receiver window (RWND) advertised by the UEs during connection establishment. Many UEs, which advertise the large RWND due to better hardware capability, can lead to multiple internet servers transmitting a large amount of data to the UEs. This phenomenon may forward a large number of data packets to be processed in User Plane Function (UPF) of a core network, which would lead to some problems, such as a packet buffering, a packet loss, and an increased Central Processing Unit (CPU) load. To ensure efficient network performance and mitigate congestions caused by the above-described problems, proactive bandwidth regulation and flow control mechanisms are necessary in the UPF.

One bandwidth regulation involves controlling a Transmission Control Protocol (TCP) throughput by adjusting the RWND size advertised by the UE in the UPF. Network operators need to regulate TCP throughput to optimize network resource allocation and ensure a consistent quality of service for their users.

One of the existing approaches to regulating the TCP throughput involves utilizing a static RWND value in the UPF. If advertised RWND size of the UE exceeds the operator-configured RWND value, the UPF intercepts and replaces the UE's advertised RWND value in the acknowledgment packet from the UE. This mechanism allows the network operator to control the available bandwidth for a specific UE, preventing excessive data transmission that could lead to congestion.

However, the regulation of bandwidth using a static RWND value results in the underutilization of UPF resources in certain scenarios. For example, the static RWND value may lead to underutilization of network resources in case of less data traffic in the UPF. The static nature of the RWND value limits its adaptability to dynamic network conditions and varying traffic patterns. In a case of load conditions in the UPF (fewer active users), UEs may still advertise a larger RWND value without overwhelmingly using the network resources.

Therefore, there is a need for an improved method that dynamically adjusts the advertised RWND value in the UPF, which allows for more efficient utilization of network resources while maintaining an optimal balance between bandwidth allocation and congestion control. Such a method would enable the network operator to regulate TCP throughput in a more adaptive and responsive manner, considering the changing network conditions and individual UE requirements.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

According to an aspect of the disclosure, a method of providing congestion control and reducing latency of data incoming to a core network, the method performed by a control plane gateway, includes: monitoring values of key performance indicators (KPIs) associated with a plurality of user plane gateways in the core network; predicting, using a machine learning (ML) model, an optimal window size respectively for each of the plurality of user plane gateways, based on the monitored values of the KPIs; and transmitting the optimal window size to the respective user plane gateway in the plurality of user plane gateways.

In an embodiment, the monitoring of the values of KPIs may include: selecting at least one KPI that influences a bandwidth capacity of a user plane gateway among the plurality of user plane gateways, wherein the at least one KPI indicates a data plane processing load of the user plane gateway; and monitoring at least one value of the selected at least one KPI.

In an embodiment, the KPIs may include at least one of: a number of active users and a number of idle users associated with the core network at a specific time-period; a number of inactive users at the specific time-period; a traffic load on a user plane gateway among the plurality of user plane gateways at the specific time-period; and a time and a type of a day.

In an embodiment, the method may further include: providing a plurality of training set of values of the KPIs along with a predetermined window size associated with each training set of values of the KPIs; and training the ML model with the plurality of training set of values of the KPIs along with the predetermined window size, wherein each KPI is assigned with a weight, based on an importance level of the KPI during the training of the pre-trained ML model.

In an embodiment, the predicting of the optimal window size may include: providing the monitored values of the KPIs to the ML model; comparing the monitored values of the KPIs with the plurality of training set of values of the KPIs; and determining the optimal window size for each of the plurality of user plane gateways based on the comparison and a total bandwidth capacity of the plurality of user plane gateways.

In an embodiment, a sum of the determined optimal window size of the plurality of user plane gateways may be less than the total bandwidth capacity of the plurality of user plane gateways.

According to an aspect of the disclosure, a method of providing congestion control and reducing latency of data incoming to a core network, the method performed by a user plane gateway, includes: receiving a Transmission Control Protocol (TCP) synchronization packet from a plurality of user equipments, wherein the TCP synchronization packet includes a receive window (RWND) size of each of the plurality of user equipments; determining whether the RWND size of each of the plurality of user equipments is greater than an optimal window size; based on a determination that the RWND size is greater than the optimal window size, electively transmitting the TCP synchronization packet with an updated RWND size to a server; and based on a determination that the RWND size is less than or equal to the optimal window size, selectively transmitting the TCP synchronization packet with the RWND size to the server.

In an embodiment, the method may further include: receiving the optimal window size from a control plane gateway, wherein the optimal window size is predicted based on monitored key performance indicators (KPIs) values associated with the user plane gateway.

In an embodiment, the method may further include: based on a determination that the RWND size is greater than the optimal window size, updating the RWND size and replacing the RWND size with the optimal window size.

According to an aspect of the disclosure, a system includes: a memory; at least one processor coupled to the memory, wherein the at least one processor is configured to: monitor values of key performance indicators (KPIs) associated with a plurality of user plane gateways of a core network; predict, using a machine learning (ML) model (or pre-trained ML model), an optimal window size respectively for each of the plurality of user plane gateways based on the monitored values of the KPIs; and transmit the optimal window size to the respective user plane gateway in the plurality of user plane gateways.

In an embodiment, the at least one processor may be further configured to: select at least one KPI that influences a bandwidth capacity of a user plane gateway among the plurality of user plane gateways, wherein the at least one KPI indicates a data plane processing load of the user plane gateway, and monitor values of the selected at least one KPI.

In an embodiment, the KPIs may include at least one of: a number of active users and a number of idle users associated with the core network at a specific time-period; a number of inactive users at the specific time-period; a traffic load on a user plane gateway at the specific time-period; and a time and a type of a day.

In an embodiment, the at least one processor may be further configured to: provide a plurality of training set of values of the KPIs along with a predetermined window size associated with each training set of values of the KPIs; and train the ML model (or pre-trained ML model) with the plurality of training set of values of the KPIs along with the predetermined window size, wherein each KPI is assigned a weight based on an importance level of the KPI during the training of the ML model (or pre-trained ML model).

In an embodiment, the at least one processor may be further configured to: provide monitored values of the KPIs to the ML model (or pre-trained ML model); compare the monitored values of the KPIs with the plurality of training set of values of the KPIs; and determine the optimal window size for each of the plurality of user plane gateways based on the comparison and a total bandwidth capacity of the plurality of user plane gateways.

In an embodiment, a sum of determined optimal window size of the plurality of user plane gateways may be less than the total bandwidth capacity of the plurality of user plane gateways.

According to an aspect of the disclosure, a system include: a memory; one or more processors operatively connected to the memory, wherein the one or more processors is configured to: receive a Transmission Control Protocol (TCP) synchronization packet from a plurality of user equipments, wherein the TCP synchronization packet includes a receive window (RWND) size of a respective user equipment of the plurality of user equipments; determine whether the RWND size of the plurality of user equipments is greater than an optimal window size; based on a determination that the RWND size is greater than the optimal window size, selectively transmit the TCP synchronization packet with an updated RWND size to a server; and based on a determination that the RWND size is less than or equal to the optimal window size, selectively transmit the TCP synchronization packet with the RWND size to the server.

In an embodiment, the one or more processors may be further configured to receive the optimal window size from a control plane gateway, wherein the optimal window size is predicted based on monitored key performance indicators (KPIs) values associated with a user plane gateway.

In an embodiment, the one or more processors may be further configured to: based on a determination that the RWND size is greater than the optimal window size, update the RWND size and replace the RWND size with the optimal window size.

The foregoing summary is illustrative only and is not intended to be in any way limiting. In addition to the illustrative embodiments, embodiments, and features described above, further embodiments, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates a schematic representation of a wireless communication system in a 5G network environment, in accordance with an embodiment of the disclosure;

FIG. 2 illustrates a system for mitigating impending congestion event, in accordance with an embodiment of the disclosure;

FIG. 3 illustrates the system for bandwidth regulation and optimal data flow control, in accordance with an embodiment of the disclosure;

FIG. 4A illustrates a data flow diagram for mitigating congestion in a network, in accordance with an embodiment of the disclosure;

FIG. 4B illustrates a signaling diagram for mitigating congestion in a network, in accordance with an embodiment of the disclosure;

FIG. 5 illustrates an environment depicting a plurality of user plane functions, in accordance with an embodiment of the disclosure;

FIG. 6 illustrates a method for determining an optimal window size, in accordance with an embodiment of the disclosure;

FIG. 7 illustrates a method for data flow control between a plurality of user equipment and a server, in accordance with an embodiment of the disclosure; and

FIG. 8 illustrates a wireless communication system according to an embodiment of the disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

In the disclosure, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

The embodiments may be described and illustrated in terms of blocks, as shown in the drawings, which carry out a described function or functions. These blocks, which may be referred to herein as a ‘user plan function (UPF) unit,’ a session management function (SMF) unit,′ or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

The terminology “user plane function”, “UPF”, “user plane gateway”, “data plane gateway”, and “UPF unit” have been used alternatively throughout the specification. The terminology “session management function”, “SMF”, “control plane gateway”, and “SMF unit” have been used alternatively throughout the specification.

The disclosure addresses the challenges of congestion by proposing a system and method for predicting an optimal window size for a plurality of user plane gateways using a pre-trained machine learning (ML) model. Generally, the window sizes the amount of data that can be in transit, somewhere in the core network, between the two. The method of the disclosure focuses on dynamically determining an appropriate window size based on various factors, such as network congestion, data traffic conditions, UE capabilities, and operator-defined policies. By dynamically adjusting the receive window size at UPF, the UPF effectively allocates bandwidth resources, optimize TCP throughput, and prevent underutilization of UPF resources, thereby improving overall network performance and user experience.

The technique disclosed herein aims to overcome the limitations of existing static received window size-based bandwidth regulation methods by introducing a dynamic approach that adapts to changing network conditions. This technique enables network operators to optimize TCP throughput, mitigate congestion, and achieve efficient resource utilization of the UPF in the 5G network environment.

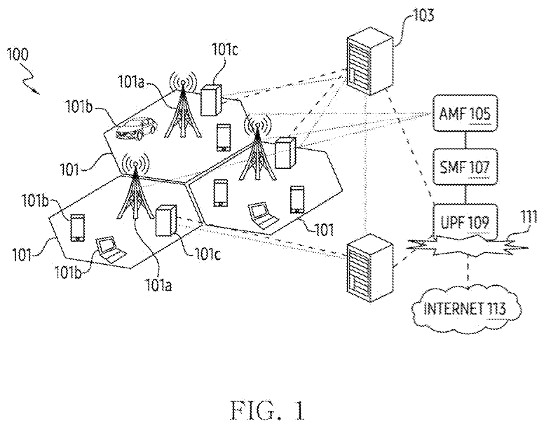

FIG. 1 illustrates a schematic representation of a wireless communication system 100 in a 5G network environment, in accordance with an embodiment of the disclosure. The wireless communication system 100 includes a plurality of cells 101, plurality of centralized units (CU) 103, an access and mobility management function (AMF) 105, a session management function (SMF) 107, a user plane function (UPF) 109, and internet 113. The AMF 105, the SMF 107 and the UPF 109 are part of the core network. Each cell of the plurality of cells 101 includes gNB 101a, a set of radio unit (RU), and distributed unit (DU) 101c corresponding to each gNB 101a, and a plurality of user equipment (UE) 101b. Each cell of the plurality of cells 101 covers a specific geographical area.

Each cell of the plurality of cells 101 includes the gNB 101a. The gNB 101a may be a Next Generation Node B. In one non-limiting embodiment, the gNB 101a is a 3GPP (3rd Generation Partnership Project) 5G Next Generation base station or an evolved Node B (eNB) that is responsible for radio communication with the plurality of UE 101b present within a cell coverage area. The gNB 101a provides radio coverage to the plurality of UE 101b of the respective cell 101. Examples of the one or more UE 101b include, but not limited to, any device used by a user to communicate and/or access content such as, mobile phones, laptops, wearables, smart vehicles, and the like.

The core network includes the AMF 105. The AMF 105 is an access mobility function in the core network that handles connection and management mobility tasks. The AMF 105 coordinates network handovers between the gNB 101a allowing users to connect to the internet 113 and access the services they are subscribed to as they move around. The AMF 105 manages the one or more UE 101b connected to the 5G network. The SMF 107 collects information related to session management from various network components such as UPF 109 and controls/coordinates those network components based on request from the AMF 105.

Furthermore, each cell of the plurality of cells 101 is in communication with the one or more CU 103. The one or more CU 103 performs baseband processing functions for the plurality of cells 101 based on dynamic needs of the plurality of cells 101. In an embodiment of the disclosure, the one or more CU 103 establishes connection between the one or more UE 101b and the UPF 109 of the core network. The UPF 109 is a function that manages user data packets as the user data packets travel between the plurality of UE 101b and the internet 113. The UPF 109 is involved in various tasks related to data forwarding and processing, ensuring efficient data transfer between the plurality of UE 101b and the internet 113. The UPF 109 receives a received window (RWND) size from the plurality of UE 101b. The RWND size refers to is the amount of receive data (in bytes) that can be buffered during a connection. In an embodiment, the plurality of UEs 101b may advertise/broadcast large RWND size as per hardware capability of the respective UEs 101b. The large RWND size advertised by the plurality of UEs 101b may overwhelm data path of the core network leading to the congestion 111 and loss of data packets.

To overcome the above challenges, the SMF 107 usually provides a static RWND value to the UPF 109. If the advertised/broadcasted RWND size exceeds the static RWND value provided by the SMF 107, the UPF 109 intercepts and replaces the broadcasted RWND with static RWND value. This mechanism allows the network operator to control the available bandwidth for a specific UE 101b, preventing excessive data transmission that could lead to the congestion 111. However, regulation of bandwidth using the static RWND size results in the underutilization of the UPF resources in certain scenarios. For example, the static RWND value is underutilized when one or more devices are not utilizing the data corresponding to the static RWND value. The static nature of the RWND size limits its adaptability to dynamic network conditions and varying traffic patterns.

The disclosure herein aims to overcome the limitations of existing static received window size-based bandwidth regulation method and system by introducing a dynamic approach that adapts to changing network conditions as illustrated in FIGS. 1 to 7.

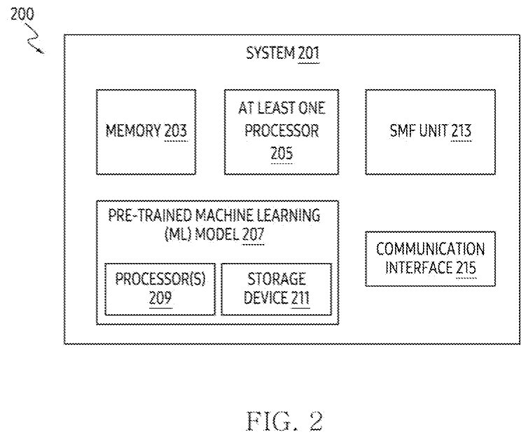

FIG. 2 illustrates a system 201 for mitigating impending congestion event, in accordance with an embodiment of the disclosure. In one embodiment, the system 201 may be a control plane gateway. In another embodiment, the system 201 may be a part of the control plane gateway.

In an embodiment, the system 201 includes a memory 203, at least one processor 205, a pre-trained machine learning (ML) model 207, a session management function (SMF) unit 213, and a communication interface 215. The SMF unit 213 may perform all session management-related functions known to a person skilled in the art.

In an embodiment, the system 201 may a part of a core network. The system 201 is configured to perform one or more operations as described herein. The at least one processor 205 is monitor values of key performance indicators (KPIs) associated with a plurality of user plane gateways of the core network. In one non-limiting embodiment, the values of key performance indicators (KPIs) associated with the plurality of user plane gateways is monitored by the SMF unit 213 and communicated to the at least one processor 205.

The KPIs indicate data plane processing load of each of the plurality of user plane gateways. In addition, the KPIs are metrics used to measure performance of network elements and services. In an embodiment, the KPIs may include at least one of: a number of active users and a number of idle users associated with the core network at a specific time-period. For example, the number of active users is one-hundred and ten (110). However, all the active users may not be actively using an internet connection and hence may be ideal. The KPIs may further comprise a number of inactive users at the specific time-period, traffic load on a user plane gateway at the specific time-period, and a time and a type of a day. The time of the day refers to peak hours (when most of the users are active) and non-peak hours (when most of the users are inactive, such as office hours and non-office hours) during the day. In addition, the type of the day (for example, in an organization) may refers to at least one of working day, holiday, and the like.

The at least one processor 205 may be configured to select one or more KPIs that influences a bandwidth capacity of a user plane gateway using the SMF unit 213. In addition, the at least one processor 205 may monitors values of the selected KPIs associated with each of the plurality of user plane gateways. The SMF unit 213 is associated with a pre-trained machine learning (ML) model 207. In an embodiment, the pre-trained ML model 207 may be present outside the SMF unit 213 but is a part of the system 201. In one non-limiting embodiment, the pre-trained ML model 207 may be a part of the SMF unit 213 of the system 201.

In an embodiment, the at least one processor 205 may be configured to predict an optimal window size respectively for each of the plurality of user plane gateways based on the monitored values of the KPIs using the pre-trained ML model 207. The pre-trained ML model 207 is trained with a plurality of training set of values of the KPIs along with a predetermined window size associated with each training set of values of the KPIs. The plurality of training set of values of the KPIs along with the predetermined window size is used to train the pre-trained ML model 207. The pre-trained ML model 207 may store the plurality of training set of values of the KPIs along with the predetermined window size in a storage device 211.

Each KPI is assigned a weight based on an importance level of the KPI during the training of the pre-trained ML model 207. For example, from a scale of 1 to 10, each KPI is assigned the weight, where 1 means lowest importance level of the KPI and 10 means highest importance level of the KPI. The pre-trained ML model 207 includes the processor 209 and the storage device 211. The processor 209 of the pre-trained ML model 207 is configured to utilize the monitored values of the KPIs and compare the monitored values of the KPIs with the plurality of training set of values of the KPIs. Further, the processor 209 of the pre-trained ML model 207 is configured to determine the optimal window size for each of the plurality of user plane gateways based on the comparison and a total bandwidth capacity of the plurality of user plane gateways. In an embodiment, a sum of determined optimal window size of the plurality of user plane gateways is always maintained less than total bandwidth capacity of the plurality of user plane gateways. The determined optimal window size ensures that resources of each user plane function (UPF) is efficiently utilized. Further the determined optimal window size provides congestion control and reduced overall latency, thereby leading to fast data transmission.

Further, the determined optimal window size is transmitted to the respective user plane gateway in the plurality of user plane gateways for optimal data flow control. The functionality associated with each user plane gateway is further explained in detail below.

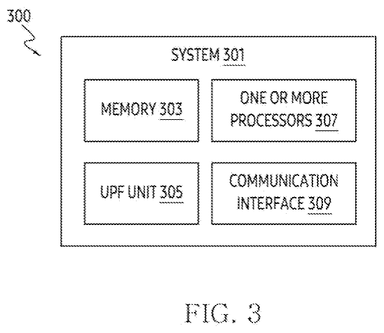

FIG. 3 illustrates a system 301 for bandwidth regulation and optimal data flow control, in accordance with an embodiment of the disclosure. In one embodiment, the system 301 may be a user plane gateway. In another embodiment, the system 301 may be a part of the user plane gateway The system 301 includes a memory 303, one or more processors 307, a user plane function (UPF) unit 305, and a communication interface 309.

The one or more processors 307 are configured to perform one or more operations as described herein. The one or more processors 307 may be configured to receive a Transmission Control Protocol (TCP) synchronization packet from a plurality of user equipment using the UPF unit 305. The plurality of user equipments transmit a TCP synchronization packet of the respective user equipment to the UPF unit 305 of the user plane gateway of the core network. The TCP synchronization packet includes a receive window (RWND) size of the respective user equipment which is broadcasted/advertised to the server. The UPF unit 305 receives the RWND size of the respective user equipment. In addition, the one or more processors 307 may be configured to receive the determined optimal window size of the UPF unit 305 from the control plane gateway, which is further discussed in detail below.

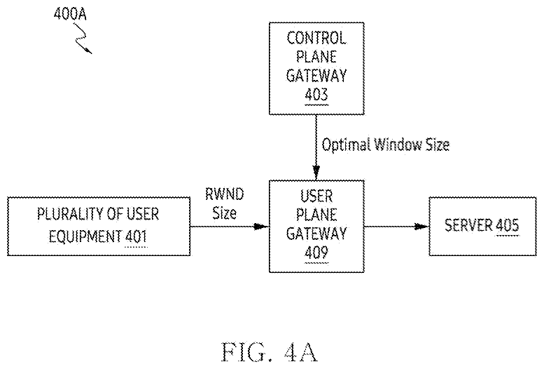

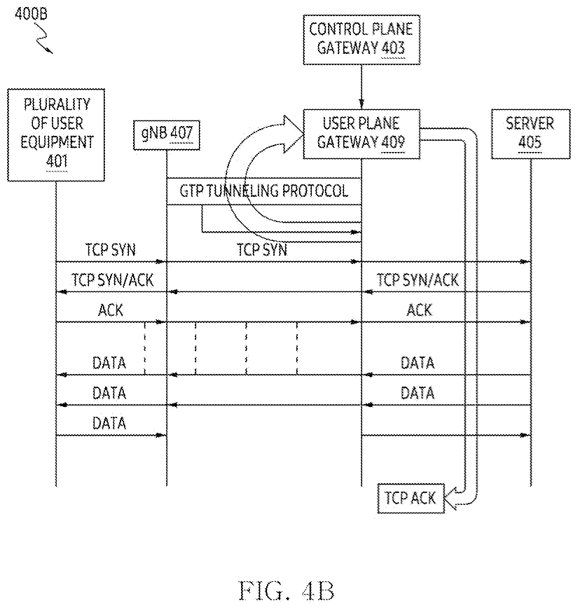

FIG. 4A illustrates a data flow diagram 400A for mitigating congestion in the core network, in accordance with an embodiment of the disclosure. The control gateway 403 may be the system 201 and the user plane gateway 409 may be the system 301. In an embodiment, the control plane gateway 403 includes the at least one processor 205 communication interface 215, and the memory 203 configured to perform the below mentioned functionality and the user plane gateway 409 includes the one or more processors 307, communication interface 309, and the memory 303 configured to perform the below mentioned functionality.

In FIG. 4A, the user plane gateway 409 is configured to receive an optimal window size from a control plane gateway 403. The optimal window size is predicted based on the monitored key performance indicators (KPIs) values associated with the user plane gateway 409. Further, the user plane gateway 409 is configured to receive a TCP synchronization packet from a plurality of user equipments 401. The TCP synchronization packet includes a receive window (RWND) size of the respective user equipment. In addition, the user plane gateway 409 receives the determined optimal window size from the control plane gateway 403. Further, the user plane gateway 409 is configured to determine whether the RWND size of the plurality of user equipments 401 is greater than the optimal window size. Based on the determination, the user plane gateway 409 is configured to transmit a TCP synchronization packet to a server 405. In an embodiment, the UPF user plane gateway 409 is configured to selectively transmit the TCP synchronization packet with an updated RWND size to the server 405, if the RWND size is greater than the optimal window size. The user plane gateway 409 is configured to update the RWND size if the RWND size is greater than the optimal window size by replacing the RWND size with the optimal window size. In another embodiment, the user plane gateway 409 is configured to selectively transmit the TCP synchronization packet with the RWND size to the server 405, if the RWND size is less than or equal to the optimal window size.

In an embodiment, the optimal window size is maximum RWND size. The maximum RWND size is calculated using the following equation:

$$\frac{{\sum }_{j = 1}^{k} R W N {D}_{j}}{{CAP}_{i} \times \frac{k}{N}} \leq 1 .$$

For example, let us assume an i^{th} UPF serving N flows (N is a total number of data flows, including all protocols that are passing through the i^{th} UPF. In the equation above, k represents total number of TCP flows passing through the i^{th} UPF, RWNDⱼ represents maximum RWND value for a jth TCP flow of the i^{th} UPF, and CAPᵢ represents total bandwidth capacity of the i^{th} UPF, considering total memory and computational capacity of the UPF.

FIG. 4B illustrates a signaling diagram 400B for mitigating congestion in the core network, in accordance with an embodiment of the disclosure. The signaling diagram 400B illustrates the plurality of user equipments 401 configured to send a TCP SYN to the user plane gateway 409. The user plane gateway 409 corresponds to the user plane gateway (system 301) FIG. 3. It is to be noted that the user plane gateway 409 (shown in FIGS. 4A and 4B) includes the UPF unit 305 (shown in FIG. 3). The TCP SYN corresponds to the TCP synchronization packet as illustrated in FIG. 4A.

The plurality of user equipments 401 may be configured to send the TCP SYN to the user plane gateway 409 through a Next Generation Node B (gNB) 407. In general, gNB 407 is a radio node which is equivalent of eNB in 4G network architecture. The gNB 407 allows the plurality of user equipments 401 to connect with the core network (control plane gateway 403 and the user plane gateway 409). In an example, the gNB 407 provides a plurality of services such as radio resource management, to the plurality of user equipments 401.

The gNB 407 provides the plurality of services using a GTP tunnelling protocol. In general, GTP tunnelling protocol refers to General Packet Radio Service (GPRS) Tunnelling Protocol that is a group of IP-based communications protocols used to carry general packet radio service (GPRS) within Global System for Mobile communication (GSM), Universal Mobile Telecommunications System (UMTS), Long Term Evolution (LTE) and 5G new radio (NR) networks. In an example, the gNB 407 is configured to forward the TCP SYN to the user plane gateway 409 from the plurality of user equipments 401. The TCP SYN includes the RWND size of the plurality of user equipments 401. The RWND size is received at the user plane gateway 409.

In addition, the user plane gateway 409 receives the optimal window size from the control plane gateway 403. Further, the user plane gateway 409 compares the RWND size with the optimal window size to determine whether the RWND size of the plurality of user equipments 401 is greater than the optimal window size. In an embodiment, if the RWND size is greater than the optimal window size, the user plane gateway 409 sends the TCP SYN with the optimal window size to the server 405. In another embodiment, if the RWND size is less than or equal to the optimal window size, the user plane gateway 409 transmits the TCP SYN with the RWND size to the server 405. Further, the server 405 transmits the TCP SYN ACK (TCP synchronization acknowledgement packet) to the plurality of user equipments 401 through the gNB 407 using the GTP tunnelling protocol. Once, the plurality of user equipments 401 receive the TCP SYN ACK, the plurality of user equipments 401 transmit ACK (acknowledgment packet) back to the server 405. After receiving the ACK from the plurality of user equipments 401, the user plane gateway 409 allows transmission of data between the plurality of user equipments 401 and the server 405.

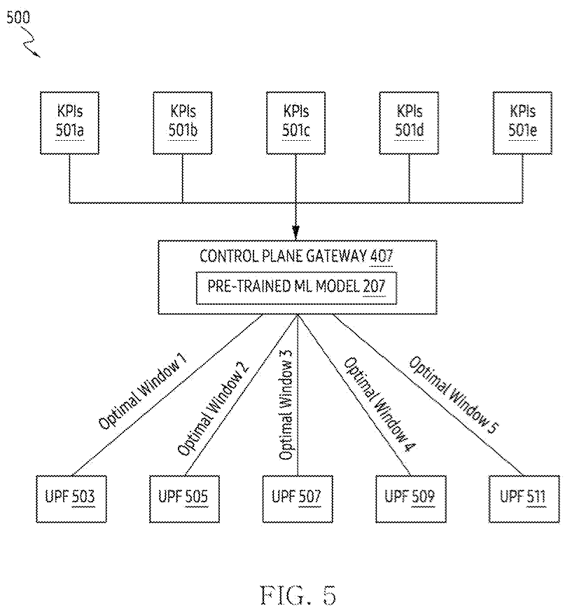

FIG. 5 illustrates an environment 500 depicting a plurality of UPFs, in accordance with an embodiment of the disclosure. The plurality of UPFs includes UPF 503, UPF 505, UPF 507, UPF 509, and UPF 511. The control plane gateway 403 is in communication with each of the plurality of UPFs 503, 505, 507, 509 and 511.

The plurality of KPIs 501a-501e of each of the plurality of UPFs 503, 505, 507, 509 and 511 may be monitored by the control plane gateway 403. In an example, the KPIs 501a indicate data plane processing load of the UPF 503. The KPIs 501b indicate data plane processing load of the UPF 507 and so on. In an embodiment, the KPIs 501a-501e may comprise a number of active users and a number of idle users associated with the respective UPF at a specific time-period. For example, a number of active users is one-hundred and ten (110). However, all the active users may not be actively using an internet connection and hence may be ideal. The KPIs 501a-501e may further include a number of inactive users at the specific time-period, traffic load on the respective user plane function at the specific time-period, and a time and a type of a day. The time of the day refers to peak hours (when most of the users are active) and non-peak hours (when most of the users are inactive, such as lunch time) during the day. In addition, the type of the day (for example, in an organization) may refers to at least one of working day, holiday, and the like.

The KPIs 501a-501e may further include load of network processor (for example, peak, average, or current) which performs fast path function, memory load (peak, average, current), user plane traffic load (for example, peak, average, or current), TCP Traffic load (for example, peak, average, or current), or available bandwidth capacity.

Further, the control plane gateway 403 includes the pre-trained ML model 207. The pre-trained ML model 207 may process the KPIs 501a along with a pre-determined window size for the UPF 503 to predict an optimal window 1 for the UPF 503 (as illustrated in FIG. 2). Further, based on the KPIs 501b, the pre-trained ML model 207 predicts an optimal window 2 for the UPF 505. Based on the KPIs 501c, the pre-trained ML model 207 predicts an optimal window 3 for the UPF 507. In addition, based on the KPIs 501d, the pre-trained ML model 207 predicts an optimal window 4 for the UPF 509. Based on the KPIs 501e, the pre-trained ML model 207 predicts an optimal window 5 for the UPF 511. The pre-trained ML model 207 predicts the optimal windows 1-5 of the respective UPFs 503, 505, 507, 509 and 511. Further, the optimal window 1 is transmitted to the UPF 503. The optimal window 2 is transmitted to the UPF 505 and so on. Furthermore, a sum of the determined optimal window 1-5 of the respective UPFs 503, 505, 507, 509 and 511 is less than total bandwidth capacity of the plurality of UPFs. The sum of determined optimal window 1-5 of the respective UPFs 503, 505, 507, 509 and 511 being less than total bandwidth capacity of the plurality of UPFs, aids in load balancing of the core network, resulting in effective bandwidth regulation Thus, the load balancing ensures distributed network traffic and efficient resource utilization across the plurality of UPFs, thereby preventing congestion and optimizing performance of the core network.

Referring again to FIG. 2 and FIG. 3, the system 201 includes the at least one processor 205 and the memory 203 and the system 301 includes the one or more processors 307, and the memory 303. The at least one processor 205 and the one or more processors 307 may be embodied as a multi-core processor, a single core processor, or a combination of one or more multi-core processors and one or more single core processors. For example, the at least one processor 205 and the one or more processors 307 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In one embodiment, the memory 203 and the memory 303 is capable of storing machine executable instructions. In an embodiment, the at least one processor 205 and the one or more processors 307 is embodied as an executor of software instructions. As such, the at least one processor 205 and the one or more processors 307 is capable of executing the instructions stored in the memory 203, 303 to perform one or more operations as described below.

The memory 203, 303 can be any type of storage accessible to the at least one processor 205 to perform respective functionalities, as explained in detail with reference to FIGS. 2 to 7. For example, the memory 203, 303 may include one or more volatile or non-volatile memories, or a combination thereof. In addition, the memory 203, 303 may be embodied as semiconductor memories, such as flash memory, mask ROM, PROM (programmable ROM), EPROM (erasable PROM), RAM (random access memory), etc. and the like.

It shall be noted that, in some embodiments, the system 201 and the system 301 may include more or fewer components than those depicted herein. The various components of the system 201, 301 may be implemented using hardware, software, firmware or any combinations thereof. Further, the various components of the system 201, 301 may be operably coupled with each other. More specifically, various components of the system 201, 301 may be capable of communicating with each other using communication channel media (such as buses, interconnects, etc.).

Further, the system 201 includes the communication interface 215 and the system 301 includes the communication interface 309. In an embodiment, the system 201 may receive the one or more KPIs associated of a plurality of UPFs via the communication interface 215. Further, the at least one processor 205 monitors the one or more KPIs and predicts the optimal window size based on the monitored KPIs (as illustrated in FIG. 2). The optimal window size is sent to the respective UPF. In an embodiment, the communication interface 309 is configured to receive the optimal window size from the control plane gateway. In an embodiment, the communication interface 309 may be configured to communicate with other entities associated with the system 301.

In an embodiment, the communication interface 215, 309 may include a transceiver configured to communicate with other entities associated with the system 201 and system 301.

In an embodiment, the communication interface 309 may include a transceiver that may be configured to communicate with other entities associated with the system 201 and the system 301. As such, the communication interface 309 is configured to receive the receive window (RWND) size from the plurality of user equipments 401. The RWND size is transmitted to the UPF unit 305. The UPF unit 305 updates the RWND size with the optimal window size if the RWND size is greater than the optimal window size (as illustrated in FIG. 3) The optimal window size is predicted to ensure that the UPF unit 305 is efficiently utilized. Further, the optimal window size provides congestion control and reduced overall latency, thereby leading to fast data transmission.

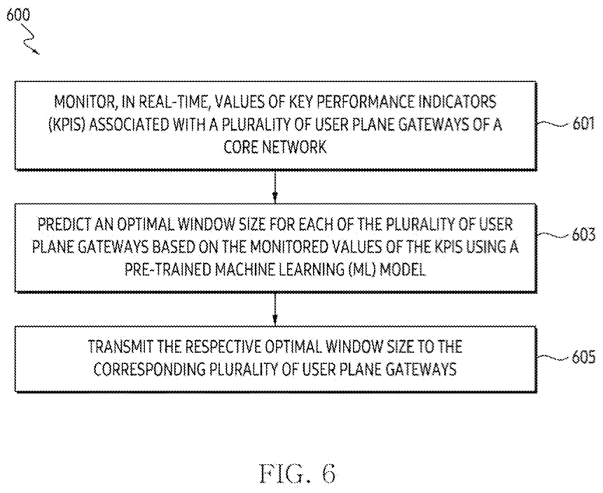

FIG. 6 illustrates a flow diagram depicting a method 600 for determining the optimal window size, in accordance with an embodiment of the disclosure. The method 600 is explained in view of FIG. 2. The method 600 includes operations performed at the system 201 of FIG. 2. The operations of the method are described herein with help of the at least one processor 205 of the system 201. It is noted that the operations of the method can be described and/or practiced by using one or more processors of a system 201 other than the at least one processor 205. To describe the method 600, the reference numerals are used in conjunction with FIGS. 1 to 5. The method 600 starts at operation 601.

At operation 601, the method 600 includes monitoring values of the KPIs associated with the plurality of UPFs 503, 505, 507, 509, 511 of the core network. The method 600 includes selecting at least one KPI that influences a bandwidth capacity of a respective UPF using the SMF unit 213. In addition, the method 600 includes monitoring values of the selected at least one KPI that is associated with at least one of the plurality of UPFs. The SMF unit 213 is associated with the pre-trained machine learning (ML) model 207 (as illustrated in FIG. 2).

Following operation 601, at operation 603, the method 600 includes predicting, using the pre-trained machine learning (ML) model 207, an optimal window size respectively for each of the plurality of UPFs 503, 505, 507, 509, 511, based on the monitored values of the KPIs. The method 600 includes training of the pre-trained ML model 207 with a plurality of training set of values of the KPIs along with a predetermined window size associated with each training set of values of the KPIs. The plurality of training set of the values of the KPIs along with the predetermined window size is used to train the pre-trained ML model 207 using the SMF unit 213. The pre-trained ML model 207 may store the plurality of training set of values of the KPIs along with the predetermined window size in a storage device 211 (as illustrated in FIG. 2).

At operation 605, the method 600 includes transmitting the optimal window size to a respective user plane gateway (UPF in the plurality of UPFs) (as illustrated in FIG. 5). Thus, the method dynamically allocates the optimal window size to the each UPF, thereby providing congestion control, reduced latency, and fast data transmission.

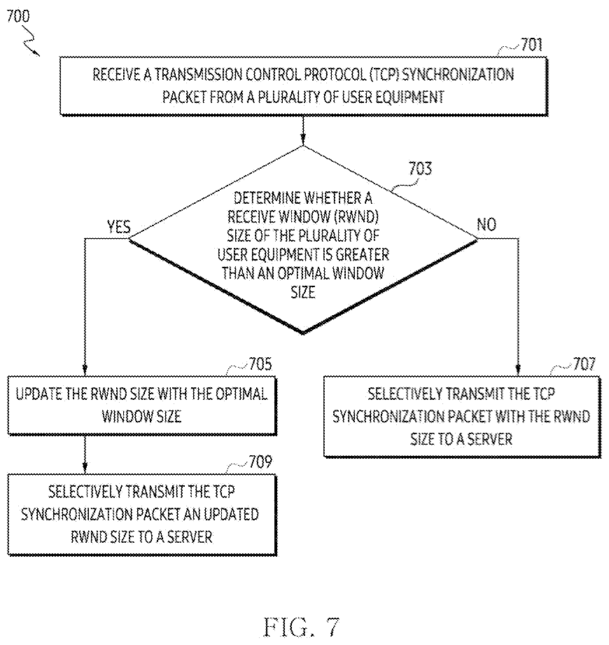

FIG. 7 illustrates a method 700 for data flow control between the plurality of user equipments 401 and the server 405, in accordance with an embodiment of the disclosure. The method 700 is explained in view of FIGS. 3, 4A and 4B. The method 700 includes operations performed at the user plane gateway. The operations of the method 700 may be performed by the one or more processors 307 of the system 301.

At operation 701, the method 700 includes receiving the TCP synchronization packet from the plurality of user equipments 401. The TCP synchronization packet includes the receive window (RWND) size of the respective user equipment. The TCP synchronization packet is received from the plurality of user equipments 401 at the user plane gateway 409 or the UPF unit 305. In addition, the method 700 includes receiving the determined optimal window size of the user plane gateway 409 from the control plane gateway 403 (as illustrated in FIG. 4A).

At operation 703, the method 700 includes determining whether the RWND size of the plurality of user equipments 401 is greater than the determined optimal window size. In addition, the method 700 includes checking a condition for the RWND size. If the RWND size is greater than the optimal window size, operation 705 and operation 709 are followed respectively. If the RWND size is less than or equal to the optimal window size, operation 707 is followed.

At operation 705, the method 700 includes updating the RWND size. The method 700 further includes updating the RWND size if the RWND size is greater than the optimal window size. The updating of the RWND size includes replacing the RWND size with the optimal window size received from the control plane gateway 407. That is, if the RWND size is greater than the optimal window size, the method 700 further includes updating the RWND size and replacing the RWND size with the optimal window size received from the control plane gateway 407.

At operation 709, the method 700 includes selectively transmitting the TCP synchronization packet with an updated RWND size to the server 405, if the RWND size is greater than the optimal window size. The updated RWND size of the plurality of UEs may ensure congestion control, reduced latency, and fast data transmission.

At operation 707, the method 700 includes selectively transmitting the TCP synchronization packet with the RWND size to the server 405, if the RWND size is less than or equal to the optimal window size.

The disclosed method 700 with reference to FIG. 7, or one or more operations may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

The method 600 and 700 collectively leads to reduced packet losses as the optimized window size helps in proactive flow control without overwhelming nodes and helps in mitigating congestion. Further, the method 600,700 ensures fair flow control among all TCP flows as the system 301 uniformly applies a dynamic upper bound on received window size. Hence, this results in fairness among all flows, as the system 301 takes non-TCP bandwidth capacity also into consideration. Further, the method 600, 700 results in optimal resource utilization in the UPF due to prediction of optimal received window size in dynamic traffic scenarios.

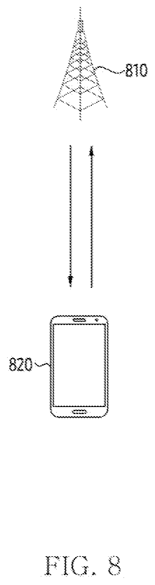

FIG. 8 illustrates a wireless communication system according to an embodiment of the disclosure.

Referring to FIG. 8, it illustrates a base station 810 and a terminal 820 as parts of nodes using a wireless channel in a wireless communication system. Although FIG. 8 illustrates only one base station, the wireless communication system may further include another base station that is the same as or similar to the base station 810.

The base station 810 is a network infrastructure that provides wireless access to the terminal 820. The base station 810 may have a coverage defined based on a distance capable of transmitting a signal. In addition to the term ‘base station’, the base station 810 may be referred to as ‘access point (AP), ‘eNodeB (eNB)’, ‘5th generation node’, ‘next generation nodeB (gNB)’, ‘wireless point’, ‘transmission/reception’, or other terms having the same or equivalent meaning thereto.

The terminal 820, which is a device used by a user, performs communications with the base station 810 through a wireless channel. A link from the base station 810 to the terminal 820 is referred to as a downlink (DL), and a link from the terminal 820 to the base station 810 is referred to as an uplink (UL). Further, although not shown in FIG. 8, the terminal 820 and other terminals may perform communications with each other through the wireless channel. In this context, a link between the terminal 820 and another terminals (device-to-device link, D2D) is referred to as a side link, and the side link may be used mixed with a PC5 interface. In some other embodiments of the disclosure, the terminal 820 may be operated without any user's involvement. According to an embodiment of the disclosure, the terminal 820 is a device that performs machine-type communication (MTC) and may not be carried by a user. In addition, according to an embodiment of the disclosure, the terminal 820 may be a narrowband (NB)-Internet of things (IoT) device.

The terminal 820 may be referred to as ‘user equipment (UE), ‘customer premises equipment (CPE), ‘mobile station’, ‘subscriber station’, ‘remote terminal’, ‘wireless terminal’, ‘electronic device’, ‘user device’, or any other term having the same or equivalent technical meaning thereto.

The base station 810 may perform beamforming with the terminal 820. The base station 810 and the terminal 820 may transmit and receive radio signals in a relatively low frequency band (e.g., FR 1 (frequency range 1) of NR). Further, the base station 810 and the terminal 820 may transmit and receive radio signals in a relatively high frequency band (e.g., FR 2 of NR (or FR 2-1, FR 2-2, FR 2-3), FR 3, or millimeter wave (mmWave) bands (e.g., 28 GHz, 30 GHz, 38 GHz, 60 GHz)). In order to improve the channel gain, the base station 810 and the terminal 820 may perform beamforming. In this context, the beamforming may include transmission beamforming and reception beamforming. The base station 810 and the terminal 820 may assign directionality to a transmission signal or a reception signal. To that end, the base station 810 and the terminal 820 may select serving beams through a beam search or beam management procedure. After the serving beams are selected, subsequent communication may be performed through a resource having a quasi-co located (QCL) relationship with a resource that has transmitted the serving beams.

A first antenna port and a second antenna port may be evaluated to be in such a QCL relationship, if the wide-scale characteristics of a channel carrying symbols on the first antenna port can be estimated from a channel carrying symbols on the second antenna port. For example, the wide-scale characteristics may include at least one of delay spread, Doppler spread, Doppler shift, average gain, average delay, and spatial receiver parameters.

Although in FIG. 8, both the base station 810 and the terminal 820 are described as performing beamforming, embodiments of the disclosure are not necessarily limited thereto. In some embodiments of the disclosure, the terminal may or may not perform beamforming. Likewise, the base station may or may not perform beamforming. That is to say, only either one of the base station and the terminal may perform beamforming, or both the base station and the terminal may not perform beamforming.

In the disclosure, a beam means a spatial flow of a signal in a radio channel, and may be formed by one or more antennas (or antenna elements), of which formation process may be referred to as beamforming. The beamforming may include at least one of analog beamforming and digital beamforming (e.g., precoding). Reference signals transmitted based on beamforming may include, for example, a demodulation-reference signal (DM-RS), a channel state information-reference signal (CSI-RS), a synchronization signal/physical broadcast channel (SS/PBCH), or a sounding reference signal (SRS). Further, for a configuration for each reference signal, an IE, such as a CSI-RS resource, an SRS-resource, or the like may be used, and the configuration may include information associated with a beam. Beam-associated information may refer to whether a corresponding configuration (e.g., CSI-RS resource) uses the same spatial domain filter as other configuration (e.g., another CSI-RS resource within the same CSI-RS resource set) or uses a different spatial domain filter, or with which reference signal is QCL, or if QCLed, what type (e.g., QCL type A, B, C, or D) it has.

According to the related art, in a communication system with a relatively large cell radius of a base station, each base station was installed so that the respective base station includes functions of a digital processing unit (or distributed unit (DU)) and a radio frequency (RF) processing unit (or radio unit (RU)). However, as high-frequency bands are used in 4th generation (4G) systems and/or its subsequent communication systems (e.g., fifth-generation (5G), and the cell coverage of a base station decreased, the number of base stations to cover a certain area has increased. Thus, it led to more increased burden of initial installation costs for communication providers to install more base stations. In order to reduce the installation costs of the base station, a structure has been proposed in which the DU and the RU of the base station are separated so that one or more RUs are connected to one DU through a wired network and one or more RUs geographically distributed are arranged to cover a specific area.

According to an aspect of the disclosure, a method of providing congestion control and reducing latency of data incoming to a core network, the method performed by a control plane gateway, includes: monitoring values of key performance indicators (KPIs) associated with a plurality of user plane gateways in the core network; predicting, using a machine learning (ML) model, an optimal window size respectively for each of the plurality of user plane gateways, based on the monitored values of the KPIs; and transmitting the optimal window size to the respective user plane gateway in the plurality of user plane gateways.

In an embodiment, the monitoring of the values of KPIs may include: selecting at least one KPI that influences a bandwidth capacity of a user plane gateway among the plurality of user plane gateways, wherein the at least one KPI indicates a data plane processing load of the user plane gateway; and monitoring at least one value of the selected at least one KPI.

In an embodiment, the KPIs may include at least one of: a number of active users and a number of idle users associated with the core network at a specific time-period; a number of inactive users at the specific time-period; a traffic load on a user plane gateway among the plurality of user plane gateways at the specific time-period; and a time and a type of a day.

In an embodiment, the method may further include: providing a plurality of training set of values of the KPIs along with a predetermined window size associated with each training set of values of the KPIs; and training the ML model with the plurality of training set of values of the KPIs along with the predetermined window size, wherein each KPI is assigned with a weight, based on an importance level of the KPI during the training of the pre-trained ML model.

In an embodiment, the predicting of the optimal window size may include: providing the monitored values of the KPIs to the ML model; comparing the monitored values of the KPIs with the plurality of training set of values of the KPIs; and determining the optimal window size for each of the plurality of user plane gateways based on the comparison and a total bandwidth capacity of the plurality of user plane gateways.

In an embodiment, a sum of the determined optimal window size of the plurality of user plane gateways may be less than the total bandwidth capacity of the plurality of user plane gateways.

According to an aspect of the disclosure, a method of providing congestion control and reducing latency of data incoming to a core network, the method performed by a user plane gateway, includes: receiving a Transmission Control Protocol (TCP) synchronization packet from a plurality of user equipments, wherein the TCP synchronization packet includes a receive window (RWND) size of each of the plurality of user equipments; determining whether the RWND size of each of the plurality of user equipments is greater than an optimal window size; based on a determination that the RWND size is greater than the optimal window size, electively transmitting the TCP synchronization packet with an updated RWND size to a server; and based on a determination that the RWND size is less than or equal to the optimal window size, selectively transmitting the TCP synchronization packet with the RWND size to the server.

In an embodiment, the method may further include: receiving the optimal window size from a control plane gateway, wherein the optimal window size is predicted based on monitored key performance indicators (KPIs) values associated with the user plane gateway.

In an embodiment, the method may further include: based on a determination that the RWND size is greater than the optimal window size, updating the RWND size and replacing the RWND size with the optimal window size.

According to an aspect of the disclosure, a system includes: a memory; at least one processor coupled to the memory, wherein the at least one processor is configured to: monitor values of key performance indicators (KPIs) associated with a plurality of user plane gateways of a core network; predict, using a machine learning (ML) model (or pre-trained ML model), an optimal window size respectively for each of the plurality of user plane gateways based on the monitored values of the KPIs; and transmit the optimal window size to the respective user plane gateway in the plurality of user plane gateways.

In an embodiment, the at least one processor may be further configured to: select at least one KPI that influences a bandwidth capacity of a user plane gateway among the plurality of user plane gateways, wherein the at least one KPI indicates a data plane processing load of the user plane gateway, and monitor values of the selected at least one KPI.

In an embodiment, the KPIs may include at least one of: a number of active users and a number of idle users associated with the core network at a specific time-period; a number of inactive users at the specific time-period; a traffic load on a user plane gateway at the specific time-period; and a time and a type of a day.

In an embodiment, the at least one processor may be further configured to: provide a plurality of training set of values of the KPIs along with a predetermined window size associated with each training set of values of the KPIs; and train the ML model (or pre-trained ML model) with the plurality of training set of values of the KPIs along with the predetermined window size, wherein each KPI is assigned a weight based on an importance level of the KPI during the training of the ML model (or pre-trained ML model).

In an embodiment, the at least one processor may be further configured to: provide monitored values of the KPIs to the ML model (or pre-trained ML model); compare the monitored values of the KPIs with the plurality of training set of values of the KPIs; and determine the optimal window size for each of the plurality of user plane gateways based on the comparison and a total bandwidth capacity of the plurality of user plane gateways.

In an embodiment, a sum of determined optimal window size of the plurality of user plane gateways may be less than the total bandwidth capacity of the plurality of user plane gateways.

According to an aspect of the disclosure, a system include: a memory; one or more processors operatively connected to the memory, wherein the one or more processors is configured to: receive a Transmission Control Protocol (TCP) synchronization packet from a plurality of user equipments, wherein the TCP synchronization packet includes a receive window (RWND) size of a respective user equipment of the plurality of user equipments; determine whether the RWND size of the plurality of user equipments is greater than an optimal window size; based on a determination that the RWND size is greater than the optimal window size, selectively transmit the TCP synchronization packet with an updated RWND size to a server; and based on a determination that the RWND size is less than or equal to the optimal window size, selectively transmit the TCP synchronization packet with the RWND size to the server.

In an embodiment, the one or more processors may be further configured to receive the optimal window size from a control plane gateway, wherein the optimal window size is predicted based on monitored key performance indicators (KPIs) values associated with a user plane gateway.

In an embodiment, the one or more processors may be further configured to: based on a determination that the RWND size is greater than the optimal window size, update the RWND size and replace the RWND size with the optimal window size.

According to an aspect of the disclosure, an electronic device comprising: a memory storing instructions, and a processor, wherein the instructions, when executed by the processor, cause the processor to: monitor values of key performance indicators (KPIs) associated with a plurality of user plane gateways of a core network; predict, using a machine learning (ML) model, an optimal window size respectively for each of the plurality of user plane gateways based on the monitored values of the KPIs, and transmit the optimal window size to the respective user plane gateway in the plurality of user plane gateways.

In an embodiment, the instructions, when executed by the processor, further cause the processor to: select at least one KPI that influences a bandwidth capacity of a user plane gateway among the plurality of user plane gateways, wherein the at least one KPI indicates a data plane processing load of the user plane gateway, and monitor values of the selected at least one KPI.

In an embodiment, the KPIs comprises at least one of: a number of active users and a number of idle users associated with the core network at a specific time-period, a number of inactive users at the specific time-period, a traffic load on a user plane gateway at the specific time-period, and a time and a type of a day.

In an embodiment, the instructions, when executed by the processor, further cause the processor to: provide a plurality of training set of values of the KPIs along with a predetermined window size associated with each training set of values of the KPIs, and train the ML model with the plurality of training set of values of the KPIs along with the predetermined window size, wherein each KPI is assigned a weight based on an importance level of the KPI during the training of the ML model.

In an embodiment, the instructions, when executed by the processor, further cause the processor to: provide monitored values of the KPIs to the ML model, compare the monitored values of the KPIs with the plurality of training set of values of the KPIs, and determine the optimal window size for each of the plurality of user plane gateways based on the comparison and a total bandwidth capacity of the plurality of user plane gateways.

In an embodiment, a sum of determined optimal window size of the plurality of user plane gateways is less than the total bandwidth capacity of the plurality of user plane gateways.

According to an aspect of the disclosure, an electronic device comprising: a memory storing instructions, and a processor, wherein the instructions, when executed by the processor, cause the processor to: receive a Transmission Control Protocol (TCP) synchronization packet from a plurality of user equipments, wherein the TCP synchronization packet comprises a receive window (RWND) size of a respective user equipment of the plurality of user equipments, determine whether the RWND size of the plurality of user equipments is greater than an optimal window size, based on a determination that the RWND size is greater than the optimal window size, selectively transmit the TCP synchronization packet with an updated RWND size to a server, and based on a determination that the RWND size is less than or equal to the optimal window size, selectively transmit the TCP synchronization packet with the RWND size to the server.

In an embodiment, the instructions, when executed by the processor, further cause the processor to receive the optimal window size from a control plane gateway, wherein the optimal window size is predicted based on monitored key performance indicators (KPIs) values associated with a user plane gateway.

In an embodiment, the instructions, when executed by the processor, further cause the processor to, based on a determination that the RWND size is greater than the optimal window size, update the RWND size and replace the RWND size with the optimal window size.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a randm-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to inventions containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While one or more embodiments have been disclosed herein, other embodiments will be apparent to those skilled in the art. The one or more embodiments disclosed herein are for purposes of illustration and are not intended to be limiting, with the true scope and spirit being indicated by the following detailed description.

What is claimed is:

1. A method of providing congestion control and reducing latency of data incoming to a core network, the method performed by a control plane gateway, comprising:
monitoring values of key performance indicators (KPIs) associated with a plurality of user plane gateways in the core network;
predicting, using a machine learning (ML) model, an optimal window size respectively for each of the plurality of user plane gateways, based on the monitored values of the KPIs; and
transmitting the optimal window size to the respective user plane gateway in the plurality of user plane gateways.

2. The method of claim 1, wherein the monitoring of the values of KPIs comprises:
selecting at least one KPI that influences a bandwidth capacity of a user plane gateway among the plurality of user plane gateways, wherein the at least one KPI indicates a data plane processing load of the user plane gateway; and
monitoring at least one value of the selected at least one KPI.

3. The method of claim 1, wherein the KPIs comprises at least one of:
a number of active users and a number of idle users associated with the core network at a specific time-period;
a number of inactive users at the specific time-period;
a traffic load on a user plane gateway among the plurality of user plane gateways at the specific time-period; and
a time and a type of a day.

4. The method of claim 1, further comprising:
providing a plurality of training set of values of the KPIs along with a predetermined window size associated with each training set of values of the KPIs; and
training the ML model with the plurality of training set of values of the KPIs along with the predetermined window size, wherein each KPI is assigned with a weight, based on an importance level of the KPI during the training of the ML model.

5. The method of claim 4, wherein the predicting of the optimal window size comprises:
providing the monitored values of the KPIs to the ML model;
comparing the monitored values of the KPIs with the plurality of training set of values of the KPIs; and
determining the optimal window size for each of the plurality of user plane gateways based on the comparison and a total bandwidth capacity of the plurality of user plane gateways.

6. The method of claim 5, wherein a sum of the determined optimal window size of the plurality of user plane gateways is less than the total bandwidth capacity of the plurality of user plane gateways.

7. A method of providing congestion control and reducing latency of data incoming to a core network, the method performed by a user plane gateway, comprising:
receiving a Transmission Control Protocol (TCP) synchronization packet from a plurality of user equipments, wherein the TCP synchronization packet comprises a receive window (RWND) size of each of the plurality of user equipments;
determining whether the RWND size of each of the plurality of user equipments is greater than an optimal window size;
based on a determination that the RWND size is greater than the optimal window size, selectively transmitting the TCP synchronization packet with an updated RWND size to a server; and
based on a determination that the RWND size is less than or equal to the optimal window size, selectively transmitting the TCP synchronization packet with the RWND size to the server.

8. The method of claim 7, further comprising:
receiving the optimal window size from a control plane gateway, wherein the optimal window size is predicted based on monitored key performance indicators (KPIs) values associated with the user plane gateway.

9. The method of claim 7, further comprising:
based on a determination that the RWND size is greater than the optimal window size, updating the RWND size and replacing the RWND size with the optimal window size.

10. An electronic device comprising:
a memory storing instructions; and
a processor,
wherein the instructions, when executed by the processor, cause the processor to:
monitor values of key performance indicators (KPIs) associated with a plurality of user plane gateways of a core network;
predict, using a machine learning (ML) model, an optimal window size respectively for each of the plurality of user plane gateways based on the monitored values of the KPIs; and
transmit the optimal window size to the respective user plane gateway in the plurality of user plane gateways.

11. The electronic device of claim 10, wherein the instructions, when executed by the processor, further cause the processor to:
select at least one KPI that influences a bandwidth capacity of a user plane gateway among the plurality of user plane gateways, wherein the at least one KPI indicates a data plane processing load of the user plane gateway, and
monitor values of the selected at least one KPI.

12. The electronic device of claim 10, wherein the KPIs comprises at least one of:
a number of active users and a number of idle users associated with the core network at a specific time-period;
a number of inactive users at the specific time-period;
a traffic load on a user plane gateway at the specific time-period; and
a time and a type of a day.

13. The electronic device of claim 10, wherein the instructions, when executed by the processor, further cause the processor to:
provide a plurality of training set of values of the KPIs along with a predetermined window size associated with each training set of values of the KPIs; and
train the ML model with the plurality of training set of values of the KPIs along with the predetermined window size, wherein each KPI is assigned a weight based on an importance level of the KPI during the training of the ML model.

14. The electronic device of claim 13, wherein the instructions, when executed by the processor, further cause the processor to:
provide monitored values of the KPIs to the ML model;
compare the monitored values of the KPIs with the plurality of training set of values of the KPIs; and
determine the optimal window size for each of the plurality of user plane gateways based on the comparison and a total bandwidth capacity of the plurality of user plane gateways.

15. The electronic device of claim 14, wherein a sum of determined optimal window size of the plurality of user plane gateways is less than the total bandwidth capacity of the plurality of user plane gateways.

16. An electronic device comprising:
a memory storing instructions; and
a processor,
wherein the instructions, when executed by the processor, cause the processor to:
receive a Transmission Control Protocol (TCP) synchronization packet from a plurality of user equipments, wherein the TCP synchronization packet comprises a receive window (RWND) size of a respective user equipment of the plurality of user equipments;
determine whether the RWND size of the plurality of user equipments is greater than an optimal window size;
based on a determination that the RWND size is greater than the optimal window size, selectively transmit the TCP synchronization packet with an updated RWND size to a server; and
based on a determination that the RWND size is less than or equal to the optimal window size, selectively transmit the TCP synchronization packet with the RWND size to the server.

17. The electronic device of claim 16, wherein the instructions, when executed by the processor, further cause the processor to receive the optimal window size from a control plane gateway, wherein the optimal window size is predicted based on monitored key performance indicators (KPIs) values associated with a user plane gateway.

18. The electronic device of claim 16, wherein the instructions, when executed by the processor, further cause the processor to:
based on a determination that the RWND size is greater than the optimal window size, update the RWND size and replace the RWND size with the optimal window size.
